(19) United States
(12) Patent Application Publication
(10) Pub. No.: US 2007/0229195 A1
(43) Pub. Date: Oct. 4, 2007

(54) BAND-PASS FILTER

(75) Inventor: YEN-YI SHIH, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/560,861

(22) Filed: Nov. 17, 2006

(30) Foreign Application Priority Data
Mar. 31, 2006 (TW) 95111405

(51) Int. Cl. H01P 1/203

(52) U.S. Cl. 333/204

(57) ABSTRACT

A band-pass filter (10) includes a first resonator (140), a second resonator (160), a third resonator (180), an input part (100), and an output part (120). The input part is for receiving electromagnetic signals. The first resonator is electronically connected to the input part, and includes a first groove (1400). The second resonator is parallel to the first resonator, and includes a second groove (1600). The third resonator is disposed between and parallel to the first resonator and the second resonator, and includes a third groove (1800). The output part is electronically connected to the second resonator, and is for transmitting the electromagnetic signals from the second resonator. The band-pass filter not only has a smaller profile, but also effectively reduces discontinuity losses.

### BACKGROUND OF THE INVENTION

1. Field of the Invention

The present invention generally relates to communication filters, and more particularly to a band-pass filter.

2. Description of Related Art

Conventionally, when a wireless network product is working, high frequency harmonics are generated due to the nonlinear properties of active components in wireless network products, thereby causing electromagnetic interference (EMI). In order to solve the above mentioned problem, manufacturers of such wireless network products often use a filter to suppress the noise generated by the harmonics.

To reduce manufacturing costs, waveguide elements, such as microstrips, are widely used as filters. Therefore, reducing profiles of the microstrips and increasing frequency ranges thereof are important considerations in the design of filters.

Therefore, a heretofore unaddressed need exists in the industry to overcome the aforementioned deficiencies and inadequacies.

### SUMMARY OF THE INVENTION

In one aspect of the embodiment, a band-pass filter includes a first resonator, a second resonator, a third resonator, an input part, and an output part. The input part is for receiving electromagnetic signals. The first resonator is electronically connected to the input part, and includes a first groove. The second resonator is parallel to the first resonator, and includes a second groove. The third resonator is disposed between and parallel to the first resonator and the second resonator, and includes a third groove. The output part is electronically connected to the second resonator, and is for transmitting the electromagnetic signals from the second resonator.

Other advantages and novel features will become more apparent from the following detailed description when taken in conjunction with the accompanying drawings, in which:

### BRIEF DESCRIPTION OF THE DRAWINGS

FIG. 1 is a schematic diagram of a band-pass filter according to an exemplary embodiment of the present invention;

FIG. 2 is a diagram of simulated test results showing a relationship between transmission and reflection coefficient and frequency of electromagnetic signals traveling through the band-pass filter according to an exemplary embodiment of the present invention;

FIG. 3 is a diagram of simulated test results showing a relationship between transmission and reflection coefficient and frequency of electromagnetic signals traveling through the band-pass filter according to another exemplary embodiment of the present invention; and

FIG. 4 is a diagram of simulated test results showing a relationship between transmission and reflection coefficient and frequency of electromagnetic signals traveling through the band-pass filter according to a further exemplary embodiment of the present invention.

### DETAILED DESCRIPTION OF THE INVENTION

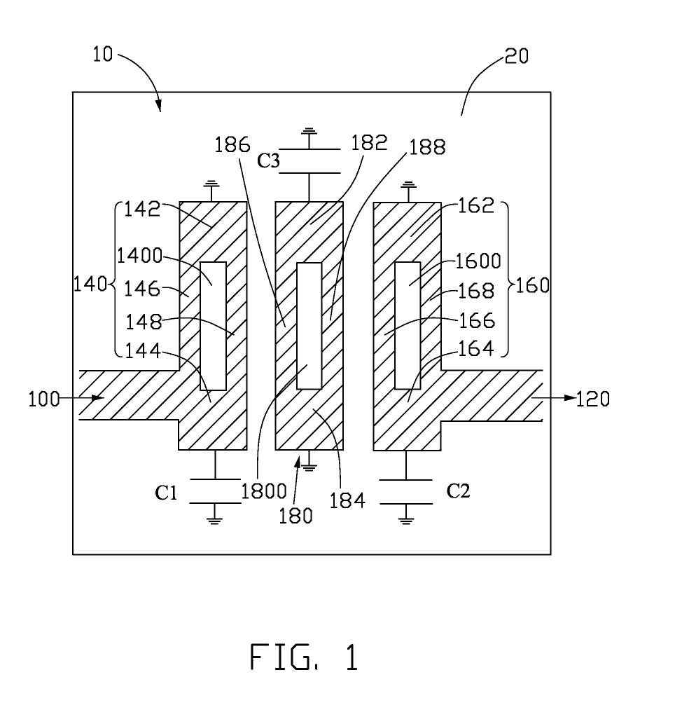

FIG. 1 is a schematic diagram of a band-pass filter 10 according to an exemplary embodiment of the present invention.

In this embodiment, the band-pass filter 10 is printed on a substrate 20, and is used for reducing harmonic electromagnetic signals. The band-pass filter 10 includes an input part 100, an output part 120, a first resonator 140, a second resonator 160, and a third resonator 180.

The input part 100 receives electromagnetic signals, and the output part 120 transmits the electromagnetic signals. The input part 100 and the output part 120 are configured in a line. In this embodiment, the input part 100 and the output part 120 are designed as 50 ohm, which is the system impedance for current communication products.

The first resonator 140 is electronically connected to the input part 100. The second resonator 160 is juxtaposed to the first resonator 140, and is electronically connected to the output part 120. The third resonator 180 is juxtaposed between the first resonator 140 and the second resonator 160. The first resonator 140 and the second resonator 160 are symmetrically disposed on two sides of the third resonator 180. In this embodiment, the first resonator 140, the second resonator 160, and the third resonator 180 are respectively in a rectangular frame shape.

The first resonator 140 includes a first groove 1400, a first coupling part 142, a second coupling part 144, a first coupling line 146, and a second coupling line 148. The first coupling part 142, the second coupling part 144, the first coupling line 146, and the second coupling line 148 cooperatively bound the first groove 1400. The first groove 1400 is substantially rectangular shaped, and is disposed at an approximate center of the first resonator 140. The first coupling part 142 and the second coupling part 144 are both disposed between the first coupling line 146 and the second coupling line 148. The first coupling line 146 is electronically connected to one side of the first coupling part 142 and one side of the second coupling part 144, and the second coupling line 148 is electronically connected to another opposite side of the first coupling part 142 and another opposite side of the second coupling part 144. The input part 100 is electronically connected to the first coupling line 146.

In the exemplary embodiment, a length and a width of the first coupling part 142 are respectively the same as a length and a width of the second coupling part 144, and a length and a width of the first coupling line 146 are respectively the same as a length and a width of the second coupling line 148. The first coupling part 142 is parallel to the second coupling part 144, the first coupling line 146 is parallel to the second coupling line 148, and the first coupling part 142 and the second coupling part 144 are perpendicular to the first coupling line 146 and the second coupling line 148. The first coupling part 142 has one end grounded. The second coupling part 144 has one end electronically connected to a capacitor C1. In the exemplary embodiment, capacitance of the capacitor C1 is 5.6 pF.

The second resonator 160 includes a second groove 1600, a third coupling part 162, a fourth coupling part 164, a third coupling line 166, and a fourth coupling line 168. The third coupling part 162, the fourth coupling part 164, the third coupling line 166, and the fourth coupling line 168 cooperatively bound the second groove 1600. The second groove 1600 is substantially rectangular shaped, and is disposed at an approximate center of the second resonator 160. The third coupling part 162 and the fourth coupling part 164 are both disposed between the third coupling line 166 and the fourth coupling line 168. The third coupling line 166 is electronically connected to one side of the third coupling part 162 and one side of the fourth coupling part 164, and the fourth coupling line 168 is electronically connected to another opposite side of the third coupling part 162 and another opposite side of the fourth coupling part 164. The output part 120 is electronically connected to the fourth coupling line 168.

In the exemplary embodiment, a length and a width of the third coupling part 162 are respectively the same as a length and a width of the fourth coupling part 164, and a length and a width of the third coupling line 166 are respectively the same as a length and a width of the fourth coupling line 168. The third coupling part 162 is parallel to the fourth coupling part 164, the third coupling line 166 is parallel to the fourth coupling line 168, and the third coupling part 162 and the fourth coupling part 164 are perpendicular to the third coupling line 166 and the fourth coupling line 168. The third coupling part 162 has one end being grounded. The fourth coupling part 164 has one end electronically connected to a capacitor C2. In the exemplary embodiment, capacitance of the capacitor C2 is 5.6 pF.

The third resonator 180 includes a third groove 1800, a fifth coupling part 182, a sixth coupling part 184, a fifth coupling line 186, and a sixth coupling line 188. The fifth coupling part 182, the sixth coupling part 184, the fifth coupling line 186, and the sixth coupling line 188 cooperatively bound the third groove 1800. The third groove 1800 is substantially rectangular shaped, and is disposed at an approximate center of the third resonator 180. The fifth coupling part 182 and the sixth coupling part 184 are both disposed between the fifth coupling line 186 and the sixth coupling line 188. The fifth coupling line 186 is electronically connected to one side of the fifth coupling part 182 and one side of the sixth coupling part 184, and the sixth coupling line 188 is electronically connected to another opposite side of the fifth coupling part 182 and another opposite side of the sixth coupling part 184.

In the exemplary embodiment, a length and a width of the fifth coupling part 182 are respectively the same as a length and a width of the sixth coupling part 184, and a length and a width of the fifth coupling line 186 are respectively the same as a length and a width of the sixth coupling line 188. The fifth coupling part 182 is parallel to the sixth coupling part 184, the fifth coupling line 186 is parallel to the sixth coupling line 188, and the fifth coupling part 182 and the sixth coupling part 184 are perpendicular to the fifth coupling line 186 and the sixth coupling line 188. The sixth coupling part 184 has one end grounded. The fifth coupling part 182 has one end electronically connected to a capacitor C3. In the exemplary embodiment, capacitance of the capacitor C3 is also 5.6 pF.

In the exemplary embodiment, shapes and sizes of the first resonator 140, the second resonator 160, and the third resonator 180 are substantially same. Lengths and widths of the first groove 1400, the second groove 1600, and the third groove 1800 are substantially same.

The electromagnetic signals feeding from the input part 100 are transmitted into the first resonator 140 firstly, and then in turn transmitted to the third resonator 180 and the second resonator 160, and eventually are output via the output part 120.

In the exemplary embodiment, a grounded end of the third resonator 180, the capacitor C1, and the capacitor C2 are disposed at one side of the band-pass filter 10, and a grounded end of the first resonator 140, a grounded end of the second resonator 160, and the capacitor C3 are disposed at another opposite side of the band-pass filter 10.

In the exemplary embodiment, lengths of the first coupling part 142, the second coupling part 144, the third coupling part 162, the fourth coupling part 164, the fifth coupling part 182, and the sixth coupling part 184 are all about 0.64 millimeter (mm), and widths of the first coupling part 142, the second coupling part 144, the third coupling part 162, the fourth coupling part 164, the fifth coupling part 182, and the sixth coupling part 184 are all about 0.24 mm. Lengths of the first coupling line 146, the second coupling line 148, the third coupling line 166, the fourth coupling line 168, the fifth coupling line 186, and the sixth coupling line 188 are all about 2.61 mm, and widths of the first coupling line 146, the second coupling line 148, the third coupling line 166, the fourth coupling line 168, the fifth coupling line 186, and the sixth coupling line 188 are all about 0.2 mm. Distances between the first resonator 140 and the second resonator 160, and between the second resonator 160 and the third resonator 180 are both 0.28 mm.

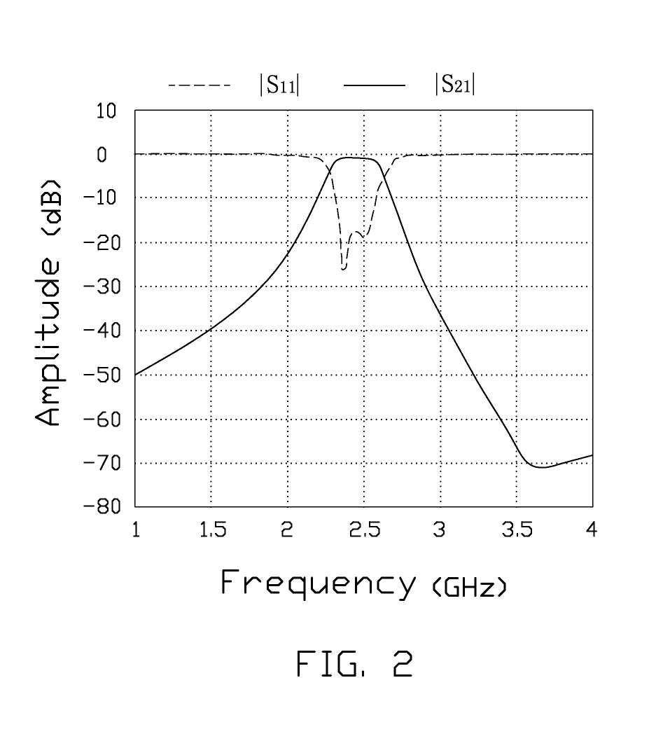

FIG. 2 is a diagram of simulated test results showing a relationship between transmission and reflection coefficient and frequency of electromagnetic signals traveling through the band-pass filter 10. The horizontal axis represents the frequency in gigahertz (GHz) of the electromagnetic signals traveling through the band-pass filter 10, and the vertical axis represents the transmission and reflection coefficient in decibels (dB) of the band-pass filter 10. The curve IS21 represents the transmission coefficient indicating a relationship between input power and output power of the electromagnetic signals traveling through the band-pass filter 10, and the transmission coefficient is calculated by the following equation:

Transmission coefficient(dB)=10*log[|S21|]=10*Log[(Output Power)/(Input Power)], when port 2 is terminated in matched loads

When electromagnetic signals travel through the band-pass filter 10, a part of the input power of the electromagnetic signals is returned to a source of the electromagnetic signals. The part of the input power returned to the source of the electromagnetic signals is called return power. The curve |S11| represents the reflection coefficient indicating a relationship between the input power and the return power of the electromagnetic signals traveling through the band-pass filter 10, and the reflection coefficient is calculated by the following equation:

Reflection coefficient(dB)=10*log[|S11|]=10*Log[(Return Power)/(Input Power)], when port 2 is terminated in matched loads

For a filter, when the output power of the electromagnetic signals in a pass band frequency range is close to the input power of the electromagnetic signals, and the return power of the electromagnetic signals is small, it means that a distortion of the electromagnetic signals is small and the performance of the band-pass filter is good. That is, the smaller the absolute value of the transmission coefficient of the electromagnetic signals is, and the bigger the absolute value of the reflection coefficient of the electromagnetic signals is, the better the performance of the filter is.

As indicated by the curve |S21| of FIG. 2, the absolute value of the transmission coefficient of the electromagnetic signals in the pass band frequency range of 2.4˜2.5 GHz is close to 0. As indicated by the curve |S11|, the absolute value of the reflection coefficient of the electromagnetic signals in the pass band frequency range is greater than 10, and the absolute value of the reflection coefficient of the electromagnetic signals beyond the pass band frequency range is less than 10. Therefore, the band-pass filter 10 in the pass band frequency range of 2.4˜2.5 GHz has good performance.

In the exemplary embodiment, the capacitances of the capacitors C1, C2, C3 are 5.6 pF. In another exemplary embodiment, the capacitances of the capacitors C1, C2, C3 can be selected from a range centered about 5.6 pF, such as 5.3 pF or 5.9 pF.

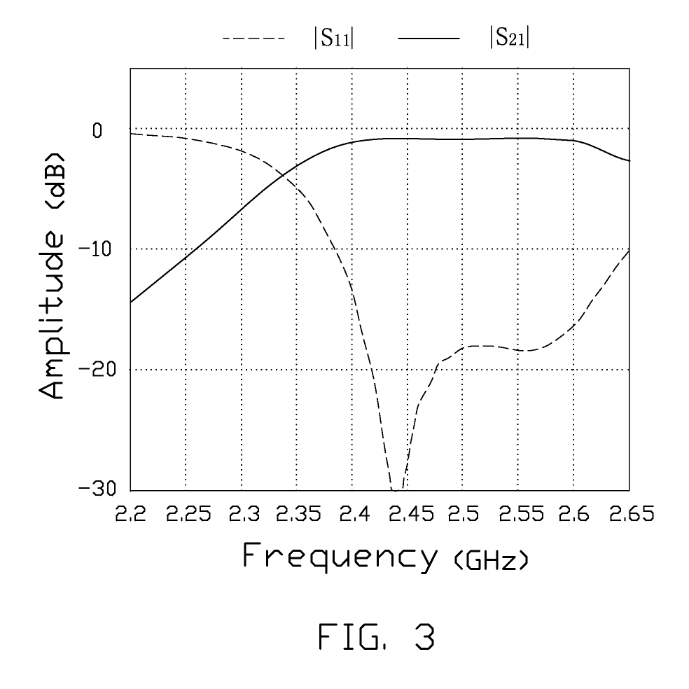

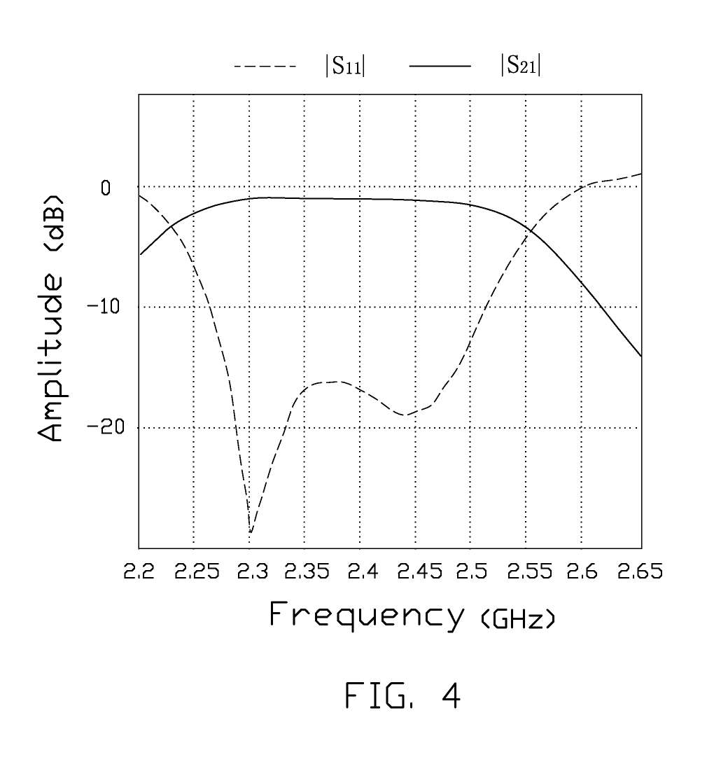

FIG. 3 is a diagram of simulated test results showing a relationship between transmission and reflection coefficient and frequency of electromagnetic signals traveling through the band-pass filter 10 using 5.3 pF capacitors. FIG. 4 is a diagram of simulated test results showing a relationship between transmission and reflection coefficient and frequency of electromagnetic signals traveling through the band-pass filter 10 using 5.9 pF capacitors.

As indicated by the curve |S21| of FIG. 3 and FIG. 4, the absolute value of the transmission coefficient of the electromagnetic signals in the pass band frequency range of 2.4˜2.5 GHz is close to 0. As indicated by the curve |S11|, the absolute value of the reflection coefficient of the electromagnetic signals in the pass band frequency range is greater than 10, and the absolute value of the reflection coefficient of the electromagnetic signals beyond the pass band frequency range is less than 10. Therefore, the band-pass filter 10 in the pass band frequency range of 2.4˜2.5 GHz employing capacitors ranged from 5.3 pF to 5.9 pF still has good performance.

In the exemplary embodiment, the band-pass filter 10 is formed by three parallel resonators 140, 160, 180, and each resonator 140, 160, 180 includes a groove 1400, 1600, 1800. The grooves 1400, 1600, and 1800 not only increase couplings between the resonators 140, 160, and 180, but also reduce sizes of each resonator 140, 160, 180. The band-pass filter 10 not only has a good filtering function and a smaller profile, but also effectively reduces discontinuity losses.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A band-pass filter, comprising:
an input part for receiving electromagnetic signals;
a first resonator electronically connected to the input part, and comprising a first groove;
a second resonator parallel to the first resonator, and comprising a second groove;
an output part electronically connected to the second resonator, for transmitting the electromagnetic signals from the second resonator; and
a third resonator disposed between and parallel to the first resonator and the second resonator, and comprising a third groove.

2. The band-pass filter of claim 1, wherein the input part and the output part are designed as 50 ohm.

3. The band-pass filter of claim 1, wherein the input part and the output part are configured in a line.

4. The band-pass filter of claim 1, wherein the first resonator has two ends, one end electronically connected to a first capacitor, and the other end grounded, the second resonator has two ends, one end electronically connected to a second capacitor, and the other end grounded, the third resonator has two ends, one end electronically connected to a third capacitor, and the other end grounded.

5. The band-pass filter of claim 4, wherein the grounded end of the third resonator, the first capacitor, and the second capacitor are located at one side of the band-pass filter, and the grounded ends of the first resonator and the second resonator, and the third capacitor are located at another side of the band-pass filter.

6. The band-pass filter of claim 5, wherein the side at which the grounded end of the third resonator, the first capacitor, and the second capacitor are located is opposite to the another side at which the grounded end of the first resonator, the grounded end of the second resonator, and the third capacitor are located.

7. The band-pass filter of claim 1, wherein shapes and sizes of the first resonator, the second resonator, and the third resonator are substantially same.

8. The band-pass filter of claim 1, wherein lengths and widths of the first groove, the second groove, and the third groove are substantially same.

9. The band-pass filter of claim 1, wherein the first groove, the second groove, and the third groove are respectively disposed at approximate centers of the first resonator, the second resonator, and the third resonator.

10. The band-pass filter of claim 1, wherein the first groove, the second groove, and the third groove are substantially rectangular.

11. The band-pass filter of claim 1, wherein the first resonator and the second resonator are symmetrically disposed on two sides of the third resonator.

12. The band-pass filter of claim 1, wherein the first resonator and the second resonator are juxtaposed to the third resonator.

13. A band-pass filter, comprising:
an input part;
a first resonator electronically connected to the input part, and having a rectangular frame shape;
a second resonator parallel to the first resonator, and having a rectangular frame shape;
an output part electronically connected to the second resonator; and
a third resonator disposed between and parallel to the first resonator and the second resonator, and having a rectangular frame shape.

14. The band-pass filter of claim 13, wherein the first resonator, the second resonator, and the third resonator are substantially the same in shape and size.

15. The band-pass filter of claim 13, wherein the first resonator and the second resonator are respectively electronically connected to a first capacitor and a second capacitor on a first side of the band-pass filter.

16. The band-pass filter of claim 15, wherein the third resonator is grounded on the first side.

17. The band-pass filter of claim 16, wherein the first resonator and the second resonator are grounded on an opposite second side of the band-pass filter.

18. The band-pass filter of claim 17, wherein the third resonator is electronically connected to a third capacitor on the second side.

19. A filter comprising:
an input part for receiving electromagnetic signals in said filter;
an output part spaced from said input part for transmitting said electromagnetic signals out of said filter;
a first resonator electrically connectable with said input part for receiving said electromagnetic signals from said input part and spaced from said output part;
a second resonator electrically connectable with said output part for transmitting said electromagnetic signals to said output part and spaced from said first resonator;
a third resonator disposed between said first and second resonators and spaced therefrom respectively in order for transmitting said electromagnetic signals between said first and second resonators; and
at least one groove formed in at least selective two of said first, second and third resonators and occupying a middle of said at least selectively two of said first, second and third resonators, respectively.

20. The filter of claim 19, wherein said at least one groove is formed in each of said first, second and third resonators and occupying said middle of said each of said first, second and third resonators.
